(19) United States
(12) Patent Application Publication
(10) Pub. No.: US 2011/0289769 A1
(43) Pub. Date: Dec. 1, 2011

(54) MAGAZINE FOR A RIVET SUPPLY APPLIANCE

(75) Inventor: Andreas SKOLAUDE, Bad Lauterberg (DE)

(73) Assignee: ECKOLD GMBH & CO. KG, St. Andreasberg (DE)

(21) Appl. No.: 13/111,310

(22) Filed: May 19, 2011

(30) Foreign Application Priority Data
May 27, 2010 (DE) 10 2010 022 031.0

(51) Int. Cl. B23Q 7/10

(52) U.S. Cl. 29/809

(57) ABSTRACT

A magazine for a rivet supply appliance, for accommodating a plurality of rivets disposed in series in a tubular housing, is distinguished by a substantially rectangular inner cross-section, having two opposing longitudinal walls of equal length and two opposing transverse walls, of which one is longer than the other, and an offset is realized within the cross-section by the transitions from the longer transverse wall to the longitudinal walls.

### CROSS REFERENCE TO RELATED APPLICATIONS

The present application claims priority under 35 U.S.C. 119 to German Application Serial No. 10 2010 022 031.0, filed on May 27, 2010, the contents of which are incorporated by reference in their entirety herein.

### FIELD OF THE INVENTION

The invention relates to a magazine for a rivet supply appliance, for accommodating a plurality of rivets disposed in series in a tubular housing, having a substantially rectangular inner cross-section, with two opposing longitudinal walls of equal length and two opposing transverse walls, of which one is longer than the other, and an offset is realized in the slot by the transitions from the longer transverse wall to the longitudinal walls.

### DISCUSSION OF BACKGROUND INFORMATION

In the magazines disclosed in DE 198 42 103 B4 or DE 100 64 241 A1 the punch rivets are stored in series in the longitudinal direction in the magazine, and in each case lie with their foot at the heat of the preceding rivet. The inner diameter of the magazine is round, and the individual rivets are guided at their head, which is of a standard size. Particularly when the riveting pliers that are supplied by the rivet supply appliance are used in the construction of a prototype, rivets are processed which differ in length, but whose head diameter is identical. In the case of the known magazine, it is then disadvantageous that, in the case where the rivet length is less than the head diameter, there is the risk of the rivets turning round in the magazine and then no longer being correctly supplied, such that the desired riveting operation can then no longer be performed.

Proceeding therefrom, a magazine for a rivet supply appliance is to be improved such that rivets of differing length can be reliably accommodated therein without the risk of short rivets turning round in the magazine.

### SUMMARY OF THE INVENTION

To solve the problem, a magazine of the generic type is distinguished by a piston located in the inside of the housing which is activable by means of an air cushion for pushing the rivets forward.

Owing to this design, the rivet is no longer accommodated in its longitudinal extent in the axial direction of the magazine, but lies transversely thereto. The guidance of each rivet is effected by means of its head, which bears on the offset realized in the slot and is supported by the longer transverse wall, such that it cannot turn round. The rivets each lie with their heads on one another. As a result, both short and longer rivets can be accommodated in the magazine. They cannot turn round, however, even when the rivet length is less than the head diameter, because the guidance is effected over a large area by means of the rivet head.

Preferably, the longitudinal walls extend parallelwise in relation to one another. Particularly when the transitions from the longer transverse wall to the longitudinal walls are rounded, the production of the rectangular inner cross-section is facilitated considerably.

Preferably, the length of the longer transverse wall is slightly greater than the diameter of the head of the rivets to be accommodated. It is thereby ensured, on the one hand, that the magazine can be easily filled and, on the other hand, turning round of even short rivets is precluded. For this purpose, the length of the longitudinal walls preferably corresponds at least to the length of the longest rivet to be accommodated.

The rectangular inner cross-section is preferably constituted by cylinder, which has a flattened portion extending in the axial direction, and in which, starting from the flattened portion, there is made a stepped rectangular slot, which extends over the full length and which is closed radially outwardly by a strip in such a way that a gap is provided between the radially inner side of the strip and the offset constituted by the slot.

It is advantageous if the stepped slot runs out radially outwards in the shape of swallow-tail, and the strip is profiled so as to correspond to the run-out in the shape of a swallow-tail. Owing to this design, the strip can be drawn out or pushed in in the axial direction of the cylinder, and the rivets can then easily be inserted next to one another in the radially outwardly open slot, the rivets being supported, by means of the broader rivet head, on the offset constituted by the step. When the strip has then been pushed back in, it assumes the guidance of the rivets on the outside of the head. The guidance of the rivet can then also be effected in that a radial slot is made in the cylinder, and a longitudinal slot, which is slightly wider than the diameter of the rivet head, and thus realized so as to be deeper than the rivet head is thick, is milled into the radially inner side of the strip. There is then no need for widening of the rectangular slot in its cross-section.

The cylinder and/or the strip is/are preferably composed of plastic, at least the strip preferably being realized so as to be transparent, so that it can be easily seen whether the magazine is still sufficiently filled with rivets.

It is particularly advantageous if the gap constituted between the strip and the offset is slightly greater than the thickness of a rivet head to be accommodated.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows the perspective view of the magazine;

FIG. 2 shows the section along the line II-II according to FIG. 1;

FIG. 2a shows an enlarged representation from FIG. 2, without rivet;

FIG. 3 shows, in cross-section, in a first position, the magazine with the rivet supply appliance realized thereon;

FIG. 4 shows, in cross-section, in a second position, the magazine with the rivet supply appliance realized thereon;

FIG. 5 shows, in cross-section, in a third position, the magazine with the rivet supply appliance realized thereon; and

FIG. 6 shows a perspective view of a piston used in the magazine.

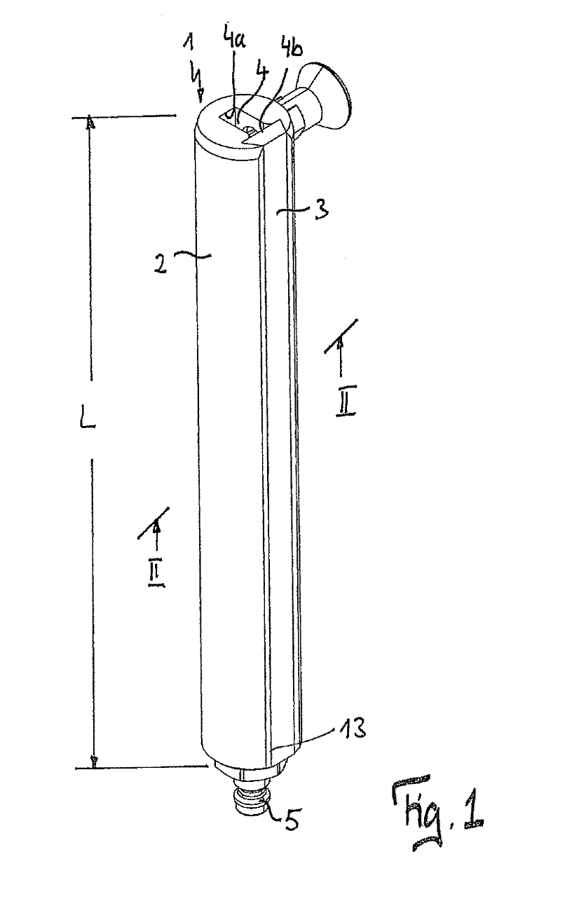

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The magazine 1 for rivets 10, in particular punch rivets, consists of the cylinder 2, which is made from plastic, and of a transparent strip 3 covering the rectangular slot 4 present on the inside of the cylinder 2. A compressed-air connection 5 is provided at the one end of the cylinder 2. The rivet supply appliance 6 is flange-mounted at the end of the cylinder 2 that is opposite the compressed-air connection 5.

The rectangular slot 4 made in the inside of the cylinder 2 widens radially outwards. It is provided with two opposing longitudinal walls 4′, 4″ that extend in the radial direction and with two opposing transverse walls 4a, 4b that extend in the axial direction. The longitudinal walls 4′, 4″ are equal in length, and the transverse wall 4b is longer than the opposing transverse wall 4a. The length of the transverse wall 4b is somewhat greater than the diameter of the rivet head 12. Realized between the transverse wall 4b and the two longitudinal walls 4′, 4″ is an offset 7, by which there is defined a gap 7a whose depth T corresponds at least to the thickness of the rivet head 12.

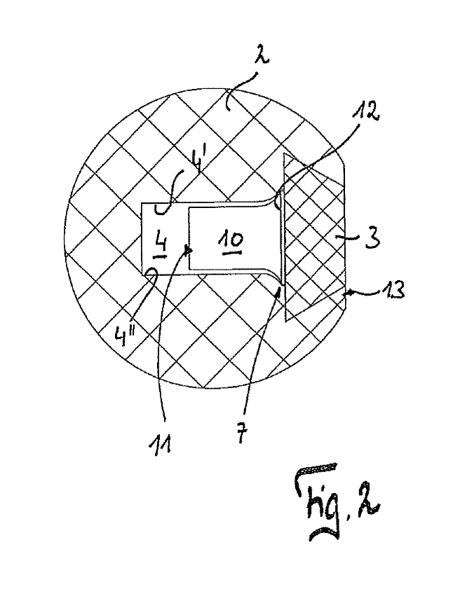

As shown by FIG. 2, the rectangular slot is realized radially outwards in the shape of a swallow-tail, and the strip 3 is profiled correspondingly at the lateral edges, such that it can be easily pushed into the cylinder 2 in the axial direction, and the wall 4b of the rectangular slot 4 is thereby realized. The rivets 10 are inserted next to one another in the rectangular slot 4 and are then supported, by means of the underside of their head 12, on the offset 7 constituting the gap 7a. In the rectangular slot 4, a piston 16 is disposed between the first rivet 10 and the compressed-air connection 5, which piston pushes the rivets forwards, in the direction of the rivet supply appliance 6, by means of an air cushion 15, and additionally enables the magazine 1 to be installed also vertically, without the rivets 10 slipping back. As can be seen from FIG. 2 the contour of the piston 16 is adapted to the inner cross-section of the housing (2) that means adapted to the rectangular slot 4 and the gap 7a.

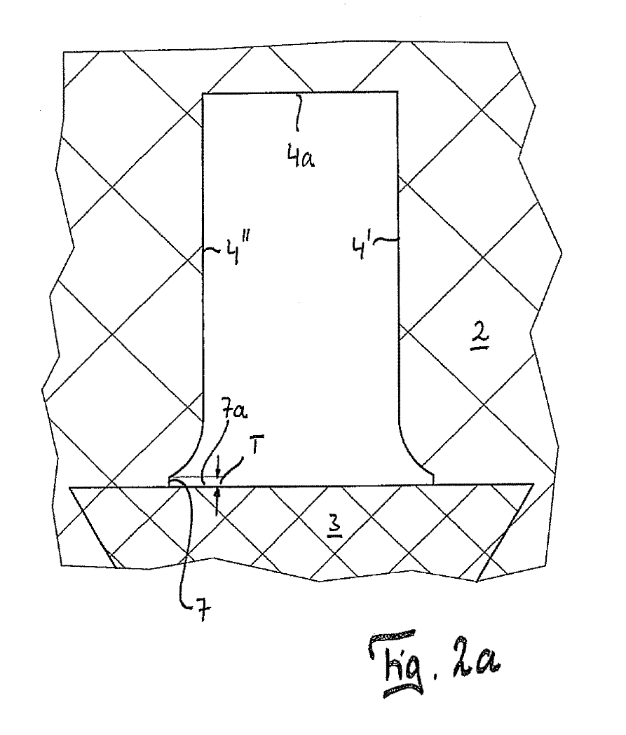

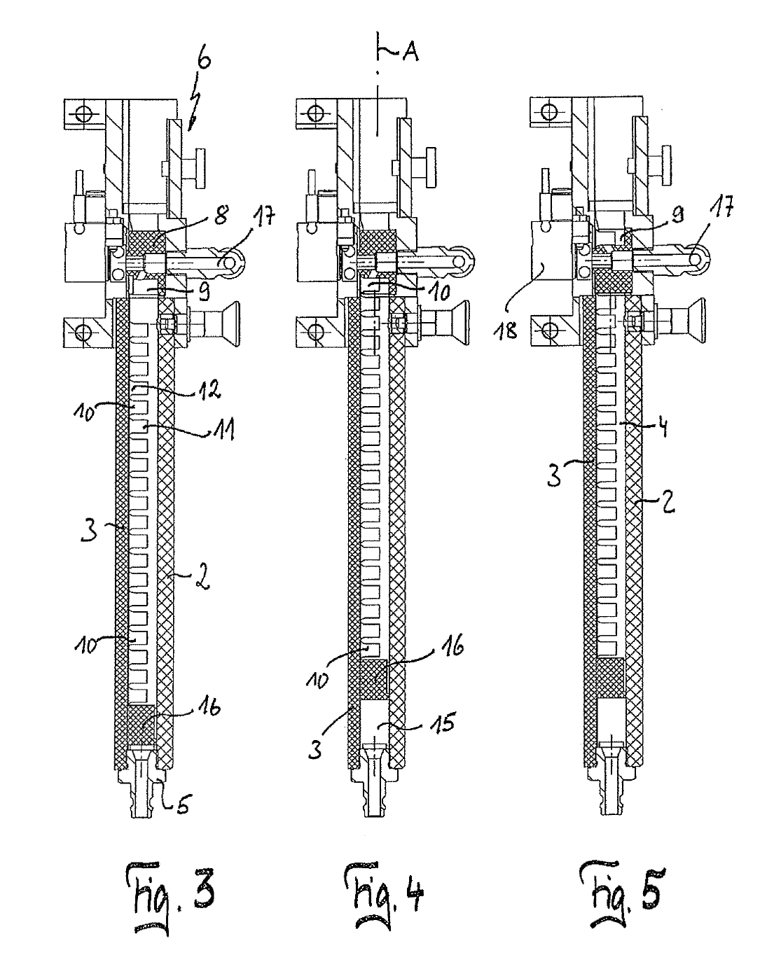

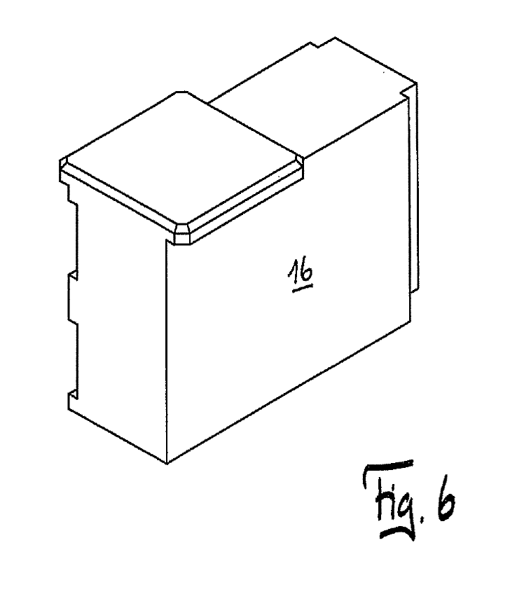

A disc 8, which is provided with a radial receiving pocket 9, is disposed and rotatably mounted in the rivet supply appliance 6. FIG. 3 shows the empty receiving pocket 9, FIG. 4 shows the receiving pocket 9 with a rivet 10 accommodated therein. By means of the swivel drive 18, the disc 8 is rotated by 180° and the rivet 10 is thereby brought into the closed position. In this position, the rectangular slot 4 is closed, as shown by FIG. 5. Via the compressed-air connection 17, a pulse of compressed air can be given into the rivet supply appliance 6, causing the rivet 10 to leave the receiving pocket 9.

The length of the longitudinal walls 4′, 4″ determines the maximum length of a magazinable rivet 10. The diameter of the rivet heads 12 is constant, event if the length of a rivet 10 is variable. The guidance of the rivet head 12 in the gap 7a enables rivets 10 of differing length to be filled into the magazine 1 and processed from the magazine 1. Turning round of a rivet 10 is precluded even if its length is shorter than the diameter of its head 12.

The gap 7a in the rectangular slot 4 can also be constituted in that, on the side that faces radially inwards, the strip 3 is provided with a longitudinal slot whose width is slightly greater than the diameter of a rivet head 12. Since the strip 3 is transparent, it can be easily seen by persons standing on the outside whether the magazine 1 is filled with a sufficient number of rivets 10, or needs to be replenished.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A magazine for a rivet supply appliance, for accommodating a plurality of rivets disposed in series in a housing, comprising:
a substantially rectangular inner cross-section, with two opposing longitudinal walls of equal length and two opposing transverse walls, of which one is longer than the other,
an offset within a cross-section by transitions from the longer transverse wall to the longitudinal walls, and
a piston in the inside which is activable by an air cushion for pushing the rivets forward.

2. The magazine according to claim 1, wherein the longitudinal walls extend parallelwise in relation to one another.

3. The magazine according to claim 1, wherein the transitions from the longer transverse wall to the longitudinal walls are rounded.

4. The magazine according to claim 1, wherein a length of the longer transverse wall is slightly greater than a diameter of a head of the rivets to be accommodated.

5. The magazine according to claim 1, wherein the length of the longitudinal walls corresponds at least to the length of the longest rivet to be accommodated.

6. The magazine according to claim 1, further comprising a cylinder, which has a flattened portion extending in an axial direction, and in which, starting from the flattened portion, there is a stepped rectangular slot, which extends over a full length and which is closed radically outwardly by a strip in such a way that a gap is provided between the radially inner side of the strip and the offset constituted by the step of the slot.

7. The magazine according to claim 6, wherein the slot runs out radially outwards in a shape of a swallow-tail, and the strip is profiled so as to correspond to a run-out in the shape of a swallow-tail.

8. The magazine according to claim 6, wherein at least one of the cylinder and the strip is composed of plastic.

9. The magazine according to claim 8, wherein at least the strip is transparent.

10. The magazine according to claim 6, wherein a depth of the gap constituted between the strip and the offset is slightly greater than a thickness of a head of the rivet to be accommodated.

11. The magazine according to claim 1, wherein a contour of the piston is adapted to an inner cross-section of the housing.
